(19) United States
(12) Patent Application Publication
(10) Pub. No.: US 2008/0073028 A1
(43) Pub. Date: Mar. 27, 2008

(54) Methods and apparatus to dispense adhesive for semiconductor packaging

(76) Inventors: Frank Yu, TaipeiHsien (TW); Kevin Jin, Taipei (TW); Muhammad F. Khan, Plano, TX (US); Mario A. Magana, Sherman, TX (US)

Correspondence Address: TEXAS INSTRUMENTS INCORPORATED, P O BOX 655474, M/S 3999, DALLAS, TX, 75265, US

(21) Appl. No.: 11/513,962

(22) Filed: Aug. 31, 2006

(51) Int. Cl. B32B 37/12; B32B 37/00

(52) U.S. Cl. 156/289; 156/330; 156/578

(57) ABSTRACT

Methods and apparatus are disclosed to dispense adhesive for semiconductor packaging. A disclosed example shower head dispenser includes a body to receive adhesive from the dispenser, and a shower head tip having a dispensing cavity in communication with the body to dispense the adhesive in a pattern. The example shower head dispenser also includes a layer of non-stick material coating a contact surface of the dispensing cavity to reduce tailing of the adhesive.

### FIELD OF THE DISCLOSURE

This disclosure relates generally to semiconductor fabrication and, more particularly, to methods and apparatus to dispense adhesive for semiconductor packaging.

### BACKGROUND

The assembly of integrated circuits involves multiple processes. For example, semiconductor devices and additional circuitry are fabricated on a wafer made of a semiconductor material such as silicon. The wafer is then cut into individual chips or dies. After the individual chip(s) or die(s) are cut from the wafer, a chip or die is then secured in a package by adhesively attaching the chip to a lead frame.

For example, FIGS. 1A-1D illustrate an example semiconductor packaging system for attaching a die 6 to a lead frame 2. In an automated assembly process, a robotic loader picks up a lead frame 2 from a stack and places it on the input area of a work holder. The lead frame 2 may then be moved from the input position and optically or mechanically aligned to a dispense position. An adhesive material such as epoxy is then dispensed on the lead frame 2 in a pattern appropriate for the size of the die 6 to be secured to the frame 2 (see FIGS. 1A and 1B).

The system of FIGS. 1A-1D includes an adhesive dispenser 3 for dispensing adhesive on a lead frame 2, and a vacuum pickup 5 for holding, transporting and/or placing a die 6 on the dispensed adhesive. The adhesive dispenser 3 of FIG. 1A includes a shower head dispenser 7 and an adhesive magazine 9. The adhesive magazine 9 is associated with a controller (not shown) which controls the position of a piston 11 within the magazine 9. The shower head dispenser 7 is removably secured to the magazine 9 by a locking collar 13. The adhesive magazine 9 is loaded with an adhesive material syringe or package 15 containing the adhesive material to be dispensed. The package 15 is compressible by the piston 11 to dispense adhesive or includes a plunger which is moveable by the piston 11 to dispense adhesive. The lower end of the package 15 has a dispensing nozzle 19 which is in communication with the shower head dispenser 7 via a valve (not shown).

When dispensing is desired, the shower head dispenser 7 is brought adjacent the lead frame 2 as shown in FIG. 1A. The controller then advances the piston 11 to compress the package 15 (or move a plunger within the package 15) by a controlled amount, thereby causing a controlled amount of adhesive to be forced out of the dispensing nozzle 19 and through the shower head dispenser 7. Thus, the amount of adhesive material dispensed by the shower head dispenser 7 is controlled by the controller by adjusting the position of the plunger 11. Unwanted leakage of adhesive from the nozzle 19 into the shower head dispenser 7 is prevented by a valve between the nozzle 19 and the shower head dispenser 7.

After a suitable adhesive pattern is dispensed, the adhesive dispenser 3 is lifted away from the lead frame 2 (see FIG. 1B). A machine vision system may then be used to inspect the frame 2, the dispensed adhesive pattern, or both. The lead frame 2 may then be transported to a bonding position. A bond head mounted on the vacuum pick-up 5 may then be used to pick up a die 6 (see FIG. 1C) and to place the die 6 on the adhesive pattern on the lead frame 2 (see FIG. 1D). Application of the appropriate bonding time, temperature, and/or bonding force results in formation of a bond between the die 6 and the lead frame 2. Again, a machine vision or other optical inspection may be performed to ensure that the placement position of the die 6 and any adhesive bleed-out from under the edge(s) of the die 6 fall within predetermined specifications.

Shower head dispensers 7 such as that shown in FIGS. 1A and 1B can be used to quickly create a pattern of adhesive material on a lead frame 2 as explained above. However, prior art shower head dispensers 7 create one or more tail(s) 24 of adhesive when the adhesive is dispensed and the shower head dispenser 7 is lifted away from the lead frame 2 (see FIG. 1B). As shown in FIGS. 1C and 1D, such tail(s) 24 may result in voids 26 in the adhesive when a die 6 is pressed against the adhesive during the bonding process. In a worst case scenario, such voids can compromise the bond.

In an effort to conserve adhesive through more precise pattern dispensing, a pen dispenser may be used in the system of FIGS. 1A-1D instead of the shower head dispenser 7. Prior art pen dispensers have a narrow head which applies a small amount of adhesive on a lead frame 2 in a desired pattern. While pen dispensers reduce adhesive waste and tailing, prior art pen dispensers dispense adhesive relatively slowly and must be mechanically moved over the lead frame to dispense adhesive in the desired pattern. Therefore, prior art pen dispensers require relatively longer amounts of time to apply adhesive to a lead frame 2 than prior art shower head dispensers, thereby resulting in lower units per hour throughput and slowing the overall fabrication process.

It is desirable to perform the process of bonding a chip 6 to a lead frame 2 as quickly as possible without leaving voids in the adhesive spread between the die 6 and the lead frame 2 and without permitting excess adhesive to bleed out beyond the edges of the die 6. However, while using a prior art pen dispenser results in savings in adhesive, reduces or prevents voids and/or reduces or prevents bleed out, using prior art pen dispensers results in relatively low units per hour production. On the other hand, while using prior art shower head dispensers results in more rapid production than prior art pen dispensers, such prior art shower head dispensers require the use of more adhesive than prior art pen dispensers and result in undesirable voids, adhesive waste, and/or bleed out.

### SUMMARY

Methods and apparatus are disclosed to dispense adhesive for semiconductor packaging. A disclosed example shower head dispenser includes a body to receive adhesive from the dispenser, and a shower head tip having a dispensing cavity in communication with the body to dispense the adhesive in a pattern. The example shower head dispenser also includes a layer of non-stick material coating a contact surface of the dispensing cavity to reduce tailing of the adhesive. In some examples, the non-stick material is Teflon. In some examples, the adhesive is at least one of epoxy, a conductive epoxy paste, or a non-conductive epoxy paste.

In some examples, the dispensing cavity is a star-shaped dispensing cavity. In some such examples, the shower head tip comprises a lumen and a floor plate, and the floor plate defines a plurality of holes to provide communication between the lumen and the star-shaped dispensing cavity.

In some examples, the dispensing cavity comprises a plurality of channels, each of the channels having a recessed corner such that the star-shaped cavity has a greater height at the corners of the star-shaped cavity than at a center of the star-shaped cavity. In some such examples, the shower head tip comprises a floor plate and the floor plate defines a plurality of holes, each of the recessed corners having a respective one of the plurality of holes.

A disclosed example method of securing a semiconductor die to a lead frame comprises: engaging the lead frame with a surface of a dispensing cavity of a shower head dispenser; at least partially filling the dispensing cavity with adhesive; lifting the shower head dispenser from the lead frame, and placing the semiconductor die on the dispensed adhesive. The surface engaging the lead frame is coated with a non-stick material to reduce tailing of the adhesive material.

In some example methods, at least partially filling the dispensing cavity comprises at least partially filling the dispensing cavity with an amount of adhesive to substantially cover a die area on the lead frame.

Another disclosed example shower head dispenser comprises a body to receive adhesive from the dispenser, and a shower head tip having a star-shaped dispensing cavity in communication with the body to dispense the adhesive in a pattern. The star-shaped dispensing cavity has a contact surface and a plurality channels. Each of the channels has a recessed corner such that the star-shaped cavity has a greater height at the corners of the star-shaped cavity than at a center of the star-shaped cavity.

In some examples, the shower head dispenser includes a layer of non-stick material coating the contact surface to reduce tailing of the adhesive.

### BRIEF DESCRIPTION OF THE DRAWINGS

FIGS. 1A-1D illustrate a prior art semiconductor packaging system for attaching a die to a lead frame.

FIG. 2A is a perspective view of an example shower head dispenser constructed in accordance with the teachings of the invention.

FIG. 2B is an exploded view of the example shower head dispenser of FIG. 2A.

FIG. 2C is an enlarged plan view of the dispensing tip of the example shower head dispenser of FIGS. 2A and 2B.

FIG. 3 is a cross-sectional view of the example shower head dispenser of FIGS. 2A-2C.

FIGS. 4A-4E are a series of cross-sectional views similar to FIG. 3 illustrating the shower head dispenser dispensing adhesive on an example lead frame.

FIG. 5 is a top view of an example pattern of deposited adhesive formed by the example process shown in FIGS. 4A-4E using the example shower head dispenser of FIGS. 2A-2C and 3.

FIG. 6 is a plan view of the tip of another example shower head dispenser.

FIG. 7 is a top view of an example pattern of deposited adhesive formed by the example shower head dispenser of FIG. 6.

FIG. 8 is a plan view of the tip of another example shower head dispenser.

FIG. 9 is a top view of an example pattern of deposited adhesive formed by the example shower head dispenser of FIG. 8.

FIG. 10 is a plan view of the tip of another example shower head dispenser.

FIG. 11 is a top view of an example pattern of deposited adhesive formed by the example shower head dispenser of FIG. 10.

FIG. 12 is a plan view of the tip of another example shower head dispenser.

FIG. 13 is a plan view of an example pattern of deposited adhesive formed by the example shower head dispenser of FIG. 12.

### DETAILED DESCRIPTION

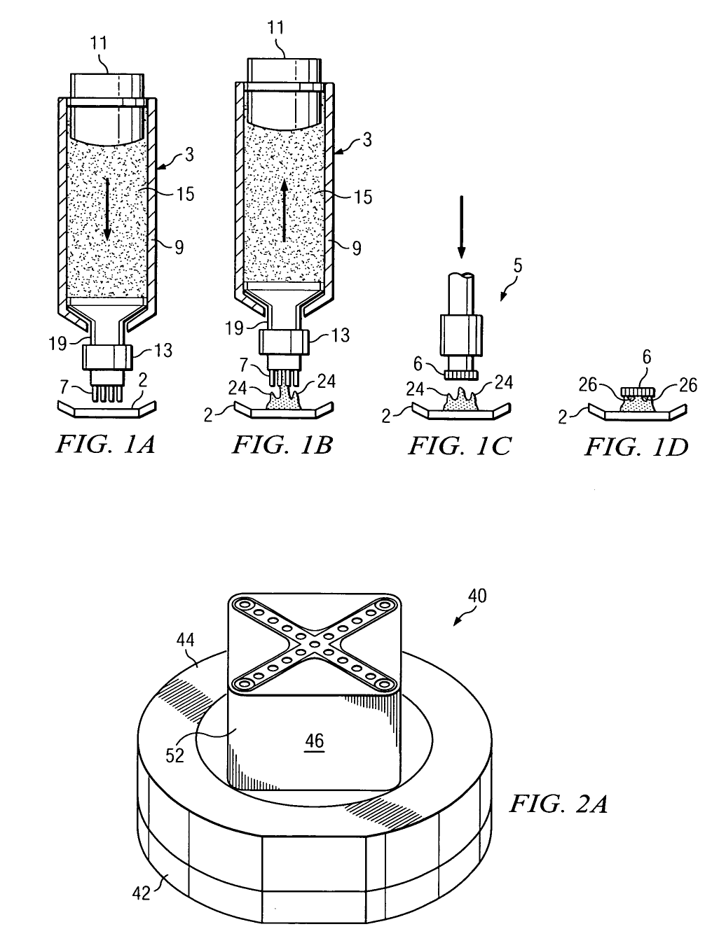

It has recently become desirable to employ epoxies having improved thermal conductivity characteristics to bond a die to a lead frame. For example, the epoxy sold under the trade name QMIJ2951, the epoxy sold under the trade name QMI-529HT and other conductive or non-conductive epoxy pastes are advantageous in bonding dies to lead frames because they improve the thermal conductivity of the resulting package. However, these epoxies exhibit high viscosity (e.g., 5 rpm), and, thus, when distributed through a prior art shower head dispenser such as that shown in FIGS. 1A and 1B above, these epoxies exhibit undesirable tailing which may result in voids in the epoxy bond. To avoid the tailing issue, these epoxies may be effectively dispensed through prior art pen dispensers, but this achievement comes at the expense of units per hour production rates.

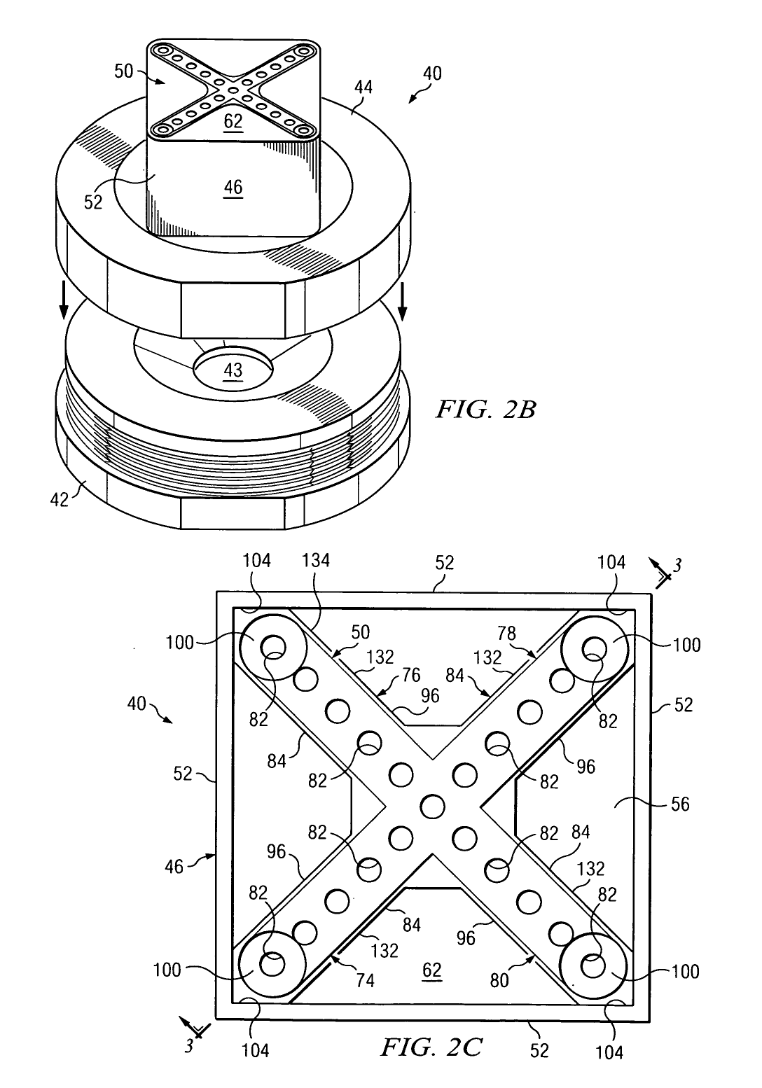

An example shower head dispenser 40 constructed in accordance with the teachings of the invention is shown in FIGS. 2A-2C. The shower head dispenser 40 of the illustrated example can be mounted on the adhesive magazine of an adhesive dispenser such as the example adhesive magazine 9 of the example adhesive dispenser 3 of FIG. 1A via a locking collar 13 or the like to dispense high viscosity adhesives such as the QMIJ2951 epoxy, the QMI-529HT epoxy or the other conductive or non-conductive epoxy pastes mentioned above without suffering from the tailing and accompanying void problems of prior art shower head dispensers. Thus, the example shower head dispenser 40 illustrated in FIGS. 2A-2C advantageously achieves higher units per hour throughput relative to prior art pen dispensers, without suffering the tailing, voiding or adhesive waste problems of prior art shower head dispensers.

Before describing the example shower head dispenser 40 in further detail, it should be noted that while reference will be made to using a relatively high viscosity die attach material, such as the epoxies sold under the trade names QMIJ2951 or QMI-529HT, with the example shower head dispenser 40, other epoxies and other adhesives, such as polyimide-based and/or silicone-based materials, could likewise be employed.

FIG. 2A is a perspective view of an example shower head dispenser 40. As shown in FIG. 2A, the example shower head dispenser 40 includes a body 42 for securing the example shower head dispenser 40 to an adhesive magazine and a shower head tip 44 for dispensing a pattern of adhesive on a lead frame (e.g., lead frame 2 of FIGS. 1A-1D) or the like. The body 42 defines a bore 43 for receiving adhesive material from the adhesive magazine. The example shower head tip 44 includes a rectangular projection 46 defining a lumen 48 to transport adhesive from the body 42 to a material dispensing cavity 50. In the illustrated example, the dispensing cavity 50 has a star shape to facilitate dispensing adhesive on a lead frame in a star shaped pattern. The example body 42 and the example shower head tip 44 are threadingly secured to one another to facilitate cleaning or repair (See FIG. 2B). A valve or seal is disposed between the adhesive magazine and the dispensing cavity 50 to ensure adhesive is dispensed into the shower head dispenser 40 in a controlled fashion.

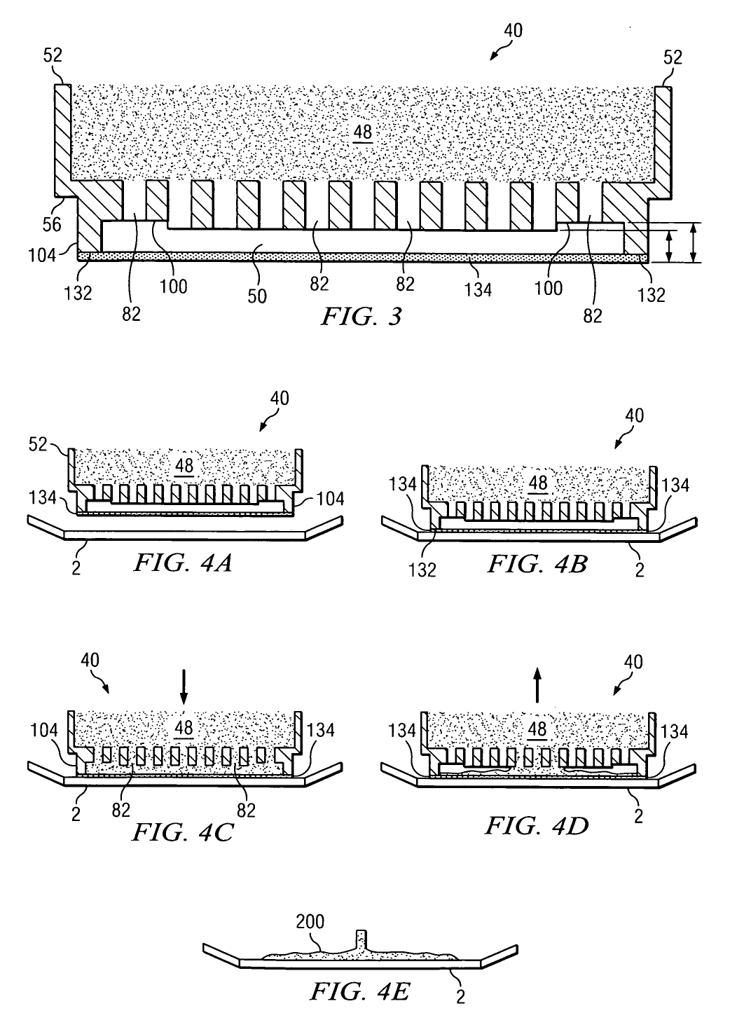

FIG. 2C is an enlarged plan view of the example shower head tip 44 of the example shower head dispenser 40 of FIGS. 2A and 2B. FIG. 3 is a cross-section view of the example shower head tip 44 taken along line 3-3 in FIG. 2C. As stated above, the projection 46 of the shower head tip 44 defines a lumen 48 to transport adhesive to an adhesive dispensing cavity 50. The lumen 48 is defined by the side walls 52 and bottom plate 56 of the shower head tip 44. The lumen 48 can have similar dimensions as the star-shaped cavity 50 for its entire length (e.g., the lumen 48 may be a star-shaped channel corresponding to the size and shape of the star-shaped cavity 50 or a rectangular channel with a diameter almost as large as the projection 46), or the lumen 48 can be smaller than the star-shaped cavity 50 for most of its length (e.g., the lumen 48 can be structured as a cylinder with a diameter much smaller than the diameter of the projection 46), but widened or flared at the tip of the lumen 48 to deliver adhesive across the entire star-shaped cavity 50.

As shown in FIG. 2C, in the illustrated example, the bottom plate 56 has a bottom surface 62 defining the star-shaped dispensing cavity 50. As explained further below, the star-shaped dispensing cavity 50 is dimensioned to ensure that an amount of adhesive sufficient to cover a bonding area between a die 6 and a lead frame 2 is quickly dispensed (e.g., in a single shot) to achieve a desired bond line thickness, while avoiding tailing and die tilt issues that could result in unsatisfactory bonding. Although the illustrated example employs a star shaped dispensing cavity 50, persons of ordinary skill in the art will understand that other patterns may be used.

The star-shaped dispensing cavity 50 of the illustrated example has four lateral arms 74, 76, 78 and 80. Each of the lateral arms 74, 76, 78 and 80 includes a number of holes 82 which are bored through the bottom plate 56 to provide communication between the dispensing cavity 50 and the lumen 48. Each of the lateral arms 74, 76, 78 and 80 of the star-shaped cavity 50 is defined by a pair of opposed raised side walls 84 and 96 and a raised corner wall 104. The side walls 84, 96 and the end walls 104 cooperate to form a closed loop raised wall projecting from the bottom plate 56. The raised wall cooperates with the bottom plate 56 to define the star-shaped dispensing cavity 50. The side of the star-shaped cavity 50 opposite the bottom plate 56 is open and can be positioned adjacent a lead frame (e.g., such as lead frame 2 of FIG. 1B) to transfer adhesive from the cavity 50 to the lead frame 2. In the illustrated example, the side walls 84, 96 and the end walls 104 cooperate to form a substantially continuous contact surface 132 to engage a lead frame (e.g., such as lead frame 2 of FIG. 1B).

To reduce tailing of adhesive when the example shower head dispenser 40 is lifted from the lead frame after dispensing adhesive, in the illustrated example the contact surface 132 formed by the side walls 84, 96 and the end walls 104 defining the star-shaped cavity 50 is coated with a layer of non-stick material 134. In the illustrated example, the non-stick material 134 is polytetrafluoroethylene (PTFE), which is commonly referred to as Teflon. This Teflon coating reduces surface tension between the adhesive pattern and the shower head dispenser 40, thereby reducing the tendency for the adhesive to lift up (i.e., tail) with the lifting shower head dispenser 40. Teflon is advantageous in this role because it is stable under a wide range of temperatures, it is chemical resistant and it exhibits low conductivity.

The volume of the star-shaped dispensing cavity 50 of the illustrated example is selected to correspond to the amount of adhesive desired to be placed on a lead frame for a die surface of interest and is, thus, application dependent. In the example illustrated in FIGS. 2A-2C and 3, the combined height of the opposed side walls 84, 96 and Teflon coating 134 relative to most of the bottom plate 56 is approximately two micro inches. However, to increase the amount of adhesive dispensed at the corners of the star-shaped dispensing cavity 50, the bottom plate 56 is recessed at each of the corners of the star-shaped cavity 50 such that the height of the Teflon coated end walls 104 relative to the bottom plate 56 is approximately three micro inches. As shown in FIG. 2C, this height difference is achieved in the illustrated example by a circular recess 100 formed at each corner of the star-shaped cavity 50. Die tilt is improved by this approach because the recesses 100 ensure that the height of the adhesive dispensed at the corners of the star shaped adhesive pattern is substantially similar to the height of the adhesive dispensed at the center of the star-shaped adhesive pattern when a die is pressed against the adhesive. In other words, the adhesive pattern dispensed using the example shower head dispenser 40 has a generally uniform height when compressed by a die.

The channel pitch of the holes 82 (i.e., the distance between the centers of two immediately adjacent holes 82) is selected to ensure substantially uniform and complete filling of the star-shaped cavity 50 with adhesive material in a short time period during the adhesive application process. Selecting the locations and pitch of the holes 82 is an empirical process based on factors such as the properties (e.g., viscosity) of the adhesive to be employed, the die size, the permissible fillet size (i.e., the height of the adhesive bond viewed from the side of the die), the area to be covered on the lead frame and the desired dispensing time. For example, it is common to require the adhesive to cover 95% of the area under the die, and for the fillet to be on the order of 0.1 mm or less. To meet these criteria using the QMI-529HT epoxy adhesive mentioned above, in the example illustrated in FIGS. 2A-2C and 3, the channels formed by the opposed side walls 84, 96 are approximately 0.7 mm in width, each of the holes has a diameter of approximately 0.2 mm, the holes are substantially evenly spaced, and the hole pitch is approximately 0.36 mm.

FIGS. 4A-4E illustrate an example process of using the example shower head dispenser 40 of FIGS. 2A-2C and 3 to dispense adhesive on a lead frame such as the lead frame 2 of FIG. 1A. In FIG. 4A, the example shower head dispenser 40 has been aligned with the lead frame (e.g., in the x-y plane of the lead frame) to ensure that the adhesive material is applied in the proper area (e.g., within the area of the die to be bonded to the lead frame). In the example of FIG. 4A, the example shower head dispenser 40 is spaced away from and out of contact with the lead frame, but is being lowered toward the lead frame. In FIG. 4B, the example shower head dispenser 40 has been lowered into contact with the upper surface of the lead frame. In particular, the PTFE layer 134 is in contact with the lead frame to form an enclosed star-shaped volume with the star-shaped dispensing cavity 50.

In FIG. 4C, a controller has been activated to force adhesive through the projection 46 of the example shower head dispenser 40, out of the holes 82 and into the star-shaped cavity 50. An amount of adhesive sufficient to fill or substantially fill the star-shaped cavity 50 is injected through the holes 82, thereby locating a star shaped pattern of adhesive on the surface of the lead frame. The amount of adhesive dispensed may be controlled by, for example, controlling the amount of movement of the piston 11 of FIG. 1A relative to the adhesive magazine 9. The controller is set to dispense an amount of adhesive appropriate for the application at issue.

After the adhesive is dispensed, the shower head dispenser 40 is quickly raised from the lead frame as shown in FIGS. 4D and 4E to produce a star-shaped adhesive pattern on the lead frame. In the illustrated example, the PTFE layer 134 provides a low friction coefficient between the contact surface 132 and the dispensed adhesive to reduce of prevent tailing of the adhesive (i.e., relative to a shower head without the PTFE layer) as the shower head dispenser 40 is raised.

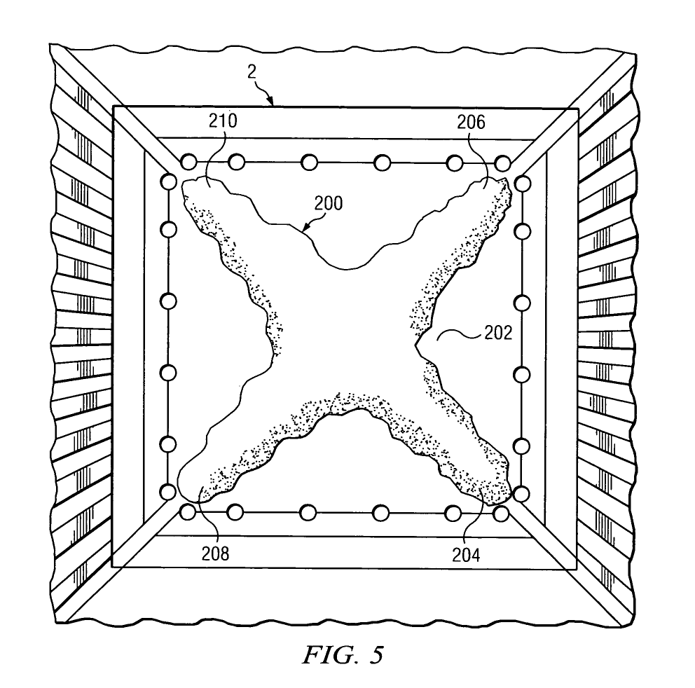

FIG. 5 is a top view of an example star-shaped adhesive pattern 200 deposited by the example shower head dispenser 40 using the example process shown in FIGS. 4A-4E. In the illustrated example, the star-shaped pattern 200 permits the adhesive material to bleed out toward the edges of a die area 202 in a substantially uniform manner without bleeding over the edges of the die area 202. The reduced tailing due to the PTFE layer 134 reduces or eliminates the creation of voids in the adhesive material pattern 200. Because of the recessed corners 100 of the star-shaped cavity 50, the adhesive has a relatively greater height at the corners of the pattern than it would have in the absence of the recesses 100 (see the arrows in the lower right corner of FIG. 3). As a result, the adhesive is more evenly distributed than in adhesive patterns generated via star-shaped shower heads without the PTFE layer. This more even distribution reduces or eliminates the occurrence of die tilt during high speed die bonding.

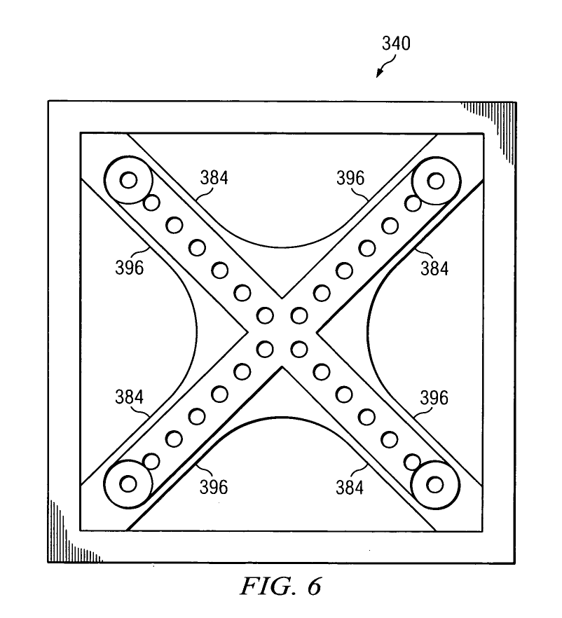

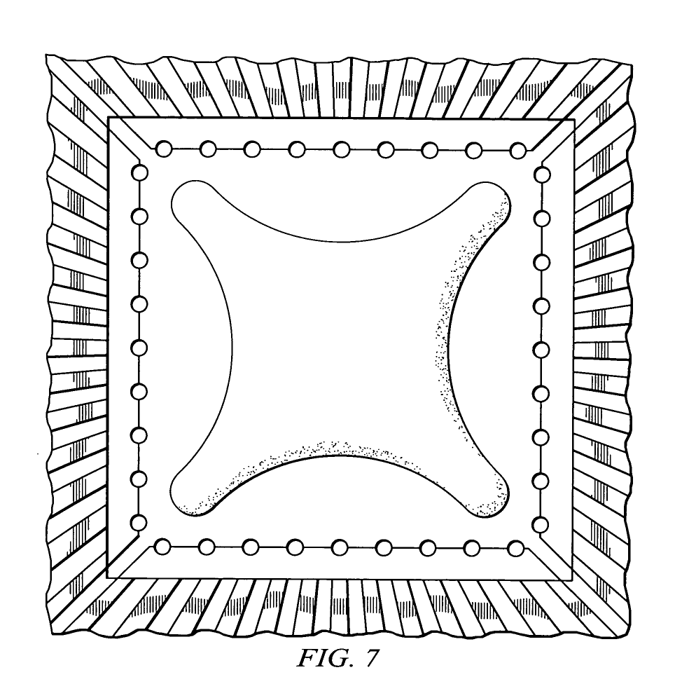

FIG. 6 is a plan view of the tip of another example shower head dispenser 340. The example shower head dispenser 340 is substantially similar to the shower head dispenser 40, but has different dimensions for a different application. In particular, the example shower head dispenser 340 of FIG. 6 is adapted for distributing QMI-529HT epoxy adhesive on dies ranging from 154-169 mils in the X-direction and 165-181 mils in the Y-direction. In the example of FIG. 6, the channels formed by the opposed side walls 384, 396 are approximately 0.5 mm in width, each of the holes has a diameter of approximately 0.2 mm, the holes are substantially evenly spaced, and the hole pitch is approximately 0.52 mm. FIG. 7 is a top view of an example pattern of deposited adhesive formed by the example shower head dispenser of FIG. 6.

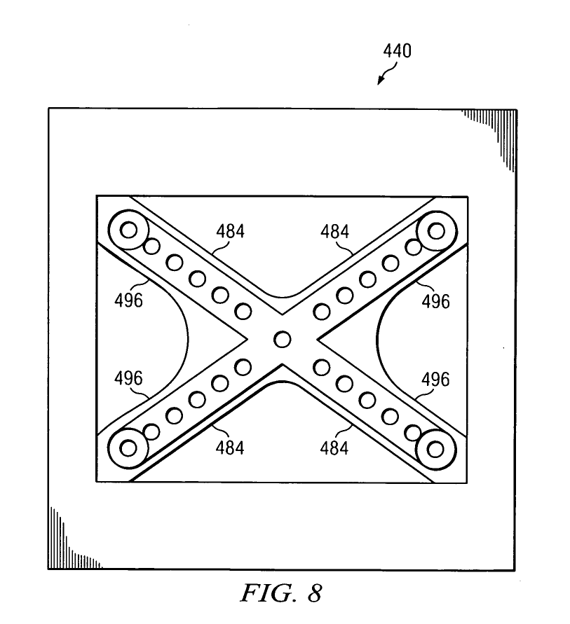

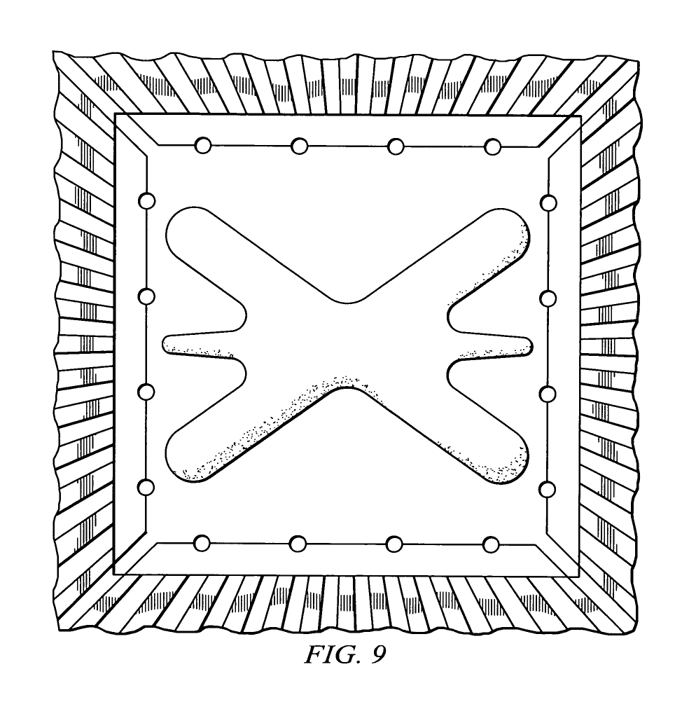

FIG. 8 is a plan view of the tip of another example shower head dispenser 440. The example shower head dispenser 440 is substantially similar to the shower head dispenser 40, but has different dimensions for a different application. In particular, the example shower head dispenser 440 of FIG. 8 is adapted for distributing QMI-529HT epoxy adhesive on dies ranging from 189-205 mils in the X-direction and 126-142 mils in the Y-direction. In the example of FIG. 8, the channels formed by the opposed side walls 484, 496 are approximately 0.5 mm in width, each of the holes has a diameter of approximately 0.2 mm, the holes are substantially evenly spaced (other than the center hole), and the hole pitch is approximately 0.69 mm. FIG. 9 is a top view of an example pattern of deposited adhesive formed by the example shower head dispenser of FIG. 8.

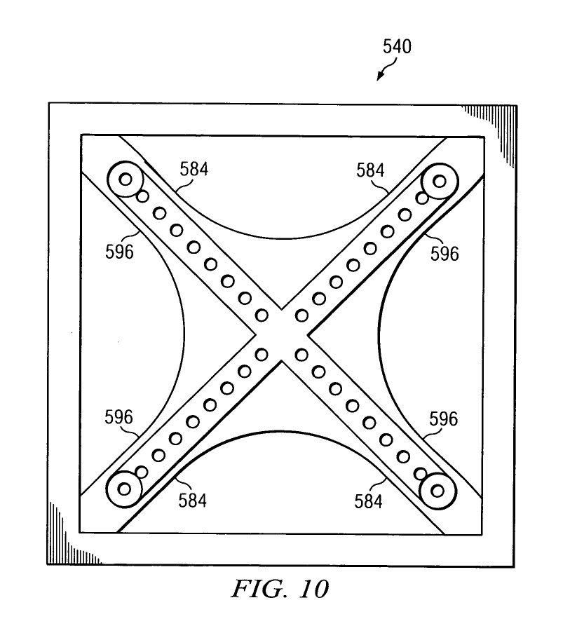

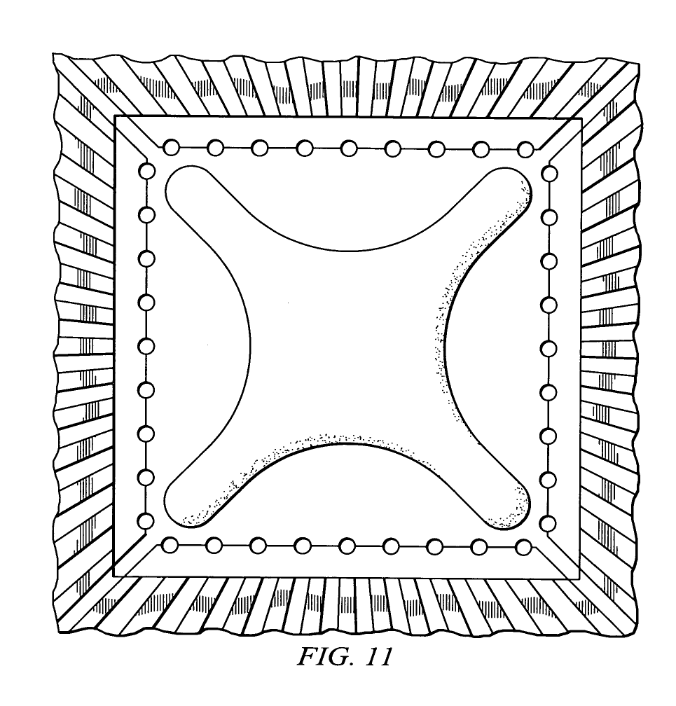

FIG. 10 is a plan view of the tip of another example shower head dispenser 540. The example shower head dispenser 540 is substantially similar to the shower head dispenser 40, but has different dimensions for a different application. In particular, the example shower head dispenser 540 of FIG. 10 is adapted for distributing QMI-529HT epoxy adhesive on dies ranging from 209-224 mils in the X-direction and 201-217 mils in the Y-direction. In the example of FIG. 10, the channels formed by the opposed side walls 584, 596 are approximately 0.5 mm in width, each of the holes has a diameter of approximately 0.2 mm, the holes are substantially evenly spaced, and the hole pitch is approximately 0.36 mm. FIG. 11 is a top view of an example pattern of deposited adhesive formed by the example shower head dispenser of FIG. 10.

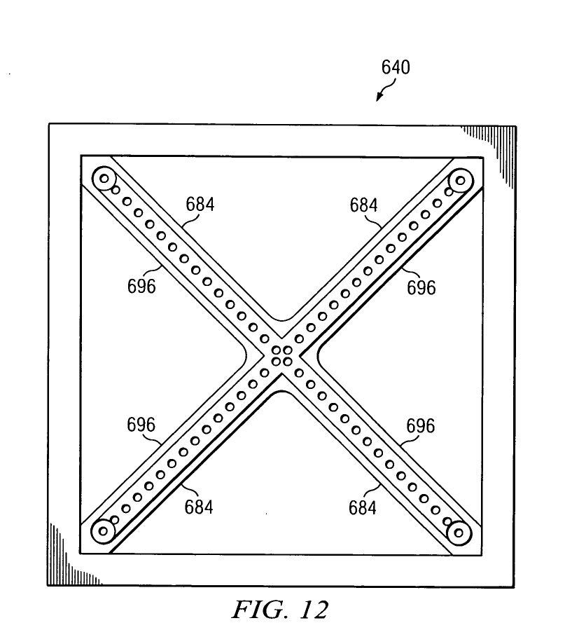

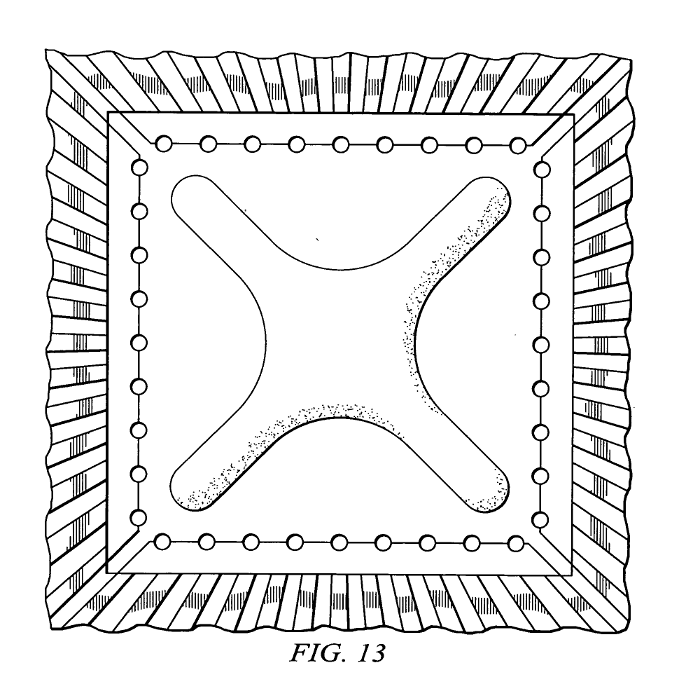

FIG. 12 is a plan view of the tip of another example shower head dispenser 640. The example shower head dispenser 640 is substantially similar to the shower head dispenser 40, but has different dimensions for a different application. In particular, the example shower head dispenser 640 of FIG. 12 is adapted for distributing QMI-529HT epoxy adhesive on dies ranging from 354-370 mils in the X-direction and 354-370 mils in the Y-direction. In the example of FIG. 12, the channels formed by the opposed side walls 684, 696 are approximately 0.5 mm in width, each of the holes has a diameter of approximately 0.2 mm, the holes are substantially evenly spaced, and the hole pitch is approximately 0.36 mm. FIG. 13 is a top view of an example pattern of deposited adhesive formed by the example shower head dispenser of FIG. 12.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. For use with a dispenser to dispense adhesive to secure a semiconductor die to a lead frame, a shower head dispenser comprising:
a body to receive adhesive from the dispenser;
a shower head tip having a dispensing cavity in communication with the body to dispense the adhesive in a pattern, the dispensing cavity having a contact surface; and
a layer of non-stick material coating the contact surface to reduce tailing of the adhesive.

2. The shower head dispenser of claim 1 wherein the dispensing cavity is a star-shaped dispensing cavity.

3. The shower head dispenser of claim 2 wherein the shower head tip comprises a lumen and a floor plate, and the floor plate defines a plurality of holes to provide communication between the lumen and the star-shaped dispensing cavity.

4. The shower head dispenser of claim 2 wherein the dispensing cavity comprises a plurality of channels, each of the channels having a recessed corner such that the star-shaped cavity has a greater height at the corners of the star-shaped cavity than at a center of the star-shaped cavity.

5. The shower head dispenser of claim 4 wherein the shower head tip comprises a floor plate and the floor plate defines a plurality of holes, each of the recessed corners having a respective one of the plurality of holes.

6. The shower head dispenser of claim 1 wherein the non-stick material is polytetrafluoroethylene (PTFE).

7. The shower head dispenser of claim 1 wherein the adhesive is at least one of epoxy, a conductive epoxy paste, or a non-conductive epoxy paste.

8. The shower head dispenser of claim 1 wherein the dispensing cavity is defined by a closed loop raised wall, and the contact surface is a continuous surface of the raised wall.

9. The shower head dispenser of claim 1 wherein the body and the shower head tip are threadingly engaged.

10. A method of securing a semiconductor die to a lead frame, the method comprising:
engaging the lead frame with a surface of a dispensing cavity of a shower head dispenser, the surface being coated with a non-stick material;
at least partially filling the dispensing cavity with adhesive;
lifting the shower head dispenser from the lead frame; and
placing the semiconductor die on the dispensed adhesive.

11. The method of claim 10 wherein the non-stick material is polytetrafluoroethylene (PTFE).

12. The method of claim 10 wherein at least partially filling the dispensing cavity comprises at least partially filling the dispensing cavity with an amount of adhesive to substantially cover a die area on the lead frame.

13. The method of claim 10 wherein the dispensing cavity is a star-shaped dispensing cavity.

14. The method of claim 13 wherein the shower head dispenser comprises a body to receive adhesive from the dispenser; and a shower head tip in communication with the body, the shower head tip further comprising a lumen and a floor plate, the floor plate defining a plurality of holes to provide communication between the lumen and the star-shaped dispensing cavity.

15. The method of claim 13 wherein the star-shaped dispensing cavity comprises a plurality of channels, each of the channels having a recessed corner such that the star-shaped cavity has a greater height at the corners of the star-shaped cavity than at a center of the star-shaped cavity.

16. The method of claim 15 wherein the shower head tip comprises a floor plate and the floor plate defines a plurality of holes, each of the recessed corners having a respective one of the plurality of holes.

17. The method of claim 10 wherein the adhesive is at least one of epoxy, a conductive epoxy paste, or a non-conductive epoxy paste.

18. For use with a dispenser to dispense adhesive to secure a semiconductor die to a lead frame, a shower head dispenser comprising:
a body to receive adhesive from the dispenser; and
a shower head tip having a star-shaped dispensing cavity in communication with the body to dispense the adhesive in a pattern, the star-shaped dispensing cavity having a contact surface and a plurality of channels, each of the channels having a recessed corner such that the star-shaped cavity has a greater height at the corners of the star-shaped cavity than at a center of the star-shaped cavity.

19. The shower head dispenser of claim 18 further comprising a layer of non-stick material coating the contact surface to reduce tailing of the adhesive.

20. The shower head dispenser of claim 18 wherein the shower head tip comprises a floor plate and the floor plate defines a plurality of holes, each of the recessed corners having a respective one of the plurality of holes.
